(19) United States
(12) Patent Application Publication
(10) Pub. No.: US 2024/0270225 A1
(43) Pub. Date: Aug. 15, 2024

(54) METHOD AND SYSTEM FOR DETERMINING PNEUMATIC CONNECTION STATUS OF A TRAILER

(71) Applicant: VIE TECHNOLOGY (EUROPE) KFT., Budapest (HU)

(72) Inventor: András FUCHS, Páty (HU)

(21) Appl. No.: 18/568,097

(22) PCT Filed: Apr. 29, 2022
(86) PCT No.: PCT/HU2022/050038

§ 371 Date: Dec. 7, 2023

(30) Foreign Application Priority Data
Jun. 18, 2021 (HU) P2100235

(51) Int. Cl. B60T 17/22; B60D 1/64; B60Q 9/00; B60T 8/17; B60T 13/68; G01H 17/00; G01M 3/02

(52) U.S. Cl. CPC B60T 17/22; B60D 1/64; B60Q 9/00; B60T 8/1708; B60T 13/683; G01H 17/00; G01M 3/02; B60T 2270/40

(57) ABSTRACT

A system for determining a pneumatic connection status of a trailer relative to a tractor includes a control unit for controlling the operation of a service brake valve and/or a parking brake valve; at least one acoustic sensor for detecting sounds and transmitting corresponding acoustic data; and a processing unit that is in data communication with the acoustic sensor for receiving the acoustic data. The processing unit is configured for processing the acoustic data and for determining a pneumatic connection status of the trailer at least on the basis of the acoustic data, wherein the at least one acoustic sensor is arranged at a trailer service brake control line of the tractor, between the service brake valve and a control line coupling head and/or at a trailer supply line of the tractor, between the parking brake valve and a supply line coupling head.

The invention relates to a system and method for determining whether a trailer is correctly pneumatically connected to a tractor. More specifically, the invention relates to an acoustic method and an acoustic system for automatically determining whether the pneumatic brake system of a trailer is correctly connected to the pneumatic system of the tractor.

Freight transport on land is often performed by vehicle combinations consisting of a tractor, e.g., a truck or a lorry, and of a trailer, e.g., a semi-trailer. Brake systems, including parking brakes, of such vehicle combinations are usually operated pneumatically and thus the operation of brakes, or disengagement of parking brakes on the trailer requires a pneumatic connector to be connected between the trailer and the tractor. This is usually performed by the driver when attaching the trailer. However, it is possible that the connection suffers a mechanical failure, or the driver connects the connector poorly or not at all. It is dangerous to tow a trailer without functioning brakes, so is towing one with its parking brakes still engaged, as the latter may lead to damage of the tires and/or the brake system, or even complete failure thereof if the situation is not recognized and the driver continues towing the trailer for a long distance. Furthermore, automatic functions of the electronic parking brake system require information on whether there is trailer connected pneumatically to the towing vehicle or not.

On vehicle combinations which are designed based on Federal Motor Vehicle Safety Standards (FMVSS), the trailers are equipped with parking brake which can be controlled from the towing vehicle, on the trailer supply line, independently from the towing vehicle's parking brake system. When no trailer is connected to the towing vehicle then the coupling head of the trailer supply/parking brake control line is always in open status. It means that if the driver trying to release the trailer's parking brake when pneumatically no trailer is connected then the air would be exhausted to the ambient. On one hand, this provides a convenient, though manual method for checking the pneumatic connection of the brake system of the trailer, because the air discharge to ambient environment results in a relatively loud noise that is recognizable by the driver from the vehicle cabin. On the other hand, such a test may exhaust a lot more compressed air, than necessary, which results in a significant waste of energy. As the compressed air is usually produced on the hydrocarbon-powered heavy vehicles themselves, wasting compressed air results in increased CO2 emissions and additional environmental pollution and thus should be avoided. Furthermore, such manual testing methods are prone to human error, even if performed well, because environmental noises may prevent recognition of a faulty status of the connection. Even worse, driver negligence may lead to completely omitting said test.

Thus, an automatic method and system is sought for improving road safety of vehicle combinations by determining whether there is a pneumatically connected trailer behind the towing vehicle or not to avoid unnecessary air loss on one hand and to prevent taking off with applied parking brakes on the trailer. Such an automatic method and system is especially advantageous on vehicles equipped with electronic parking brakes because the automatic method and system may feed information on the presence of a trailer to the electronic parking brake system automatically thus eliminating the need for manual input. This improves driver comfort, and more importantly, improves the safety of operation by avoiding the possibility of human error regarding the manual information input. An automatic system is even more important for autonomous, self-driving or remote-controlled vehicles, where a driver is not present for performing the connection check.

There are numerous attempts in the prior art for the detecting the presence and/or checking the connection status of a trailer.

US 2020286311 discloses a brake controller apparatus for audible verification of brake circuit operation. The apparatus comprises a control unit suitable for receiving a trigger signal and for actuating a pneumatic brake system according to a predetermined waveform, for example an electrically actuated brake solenoid is made to oscillate at a frequency to generate an audible sound. The audible signal produced by the specific waveform may be heard by driver. Such a system aids the driver in an audible brake check, but still relies on the active participation of the driver, the hearing of the driver, and may be compromised by environmental noises.

DE 19955798 discloses a trailer detection device that detects whether a trailer is coupled to the tractor via a compressed air coupling. A pneumatic brake system is controlled to emit a relatively short air burst when performing the detection. A pressure sensor is arranged within the pneumatic piping near the coupling. Said sensor detects the change of pressure in the pneumatic line during the air burst and the presence or absence of a pneumatically connected trailer is determined on the basis of the gradient of the time-pressure curve measured by the sensor. A significant drawback of this system is that it is susceptible to erroneous detection of either an absence or presence of a trailer due to the fact that the volume of the pneumatic connecting lines and the pneumatic tanks of the trailer may vary in a relatively large range and thus a short air pulse is often insufficient for the reliable determination of whether the pneumatic line is open to the environment or connected to a large volume tank.

CA 2236053 discloses a truck and trailer safety monitoring system having a sensor pack located on the trailer unit for detecting a fault and providing a data signal indicative thereof, and a monitoring console located on the tractor for receiving and analyzing the data signal and providing information to the driver to identify the type and location of the fault. The sensor pack comprises a contact microphone for picking up the sound of brakes and other systems. A possible fault of the brake system is determined on the basis of a comparison of specific pieces of recorded volume and frequency information in relation to corresponding volume and frequency data corresponding to normal operation.

Accordingly, the objective of the present invention is to provide a method and system for reliable detection of the presence or absence of a pneumatically connected brake system of a trailer.

The present invention is based on the recognition, that some specific features of the acoustic phenomena occurring when discharging compressed air into the environment or into a closed space differ significantly and thus provide a reliable means for automatically detecting whether the pneumatic system of a trailer is connected, while minimizing the amount of compressed air used for said test.

The above objective has been achieved on one hand by a system according to claim 1. Preferred exemplary embodiments of the system are set out in the dependent claims. The above objective has been achieved on the other hand, by a method according to claim 9. Preferred exemplary variants of the method are set out in the dependent claims.

In what follows, the invention, especially preferred exemplary embodiments thereof are described in detail with reference to the accompanying drawings, wherein

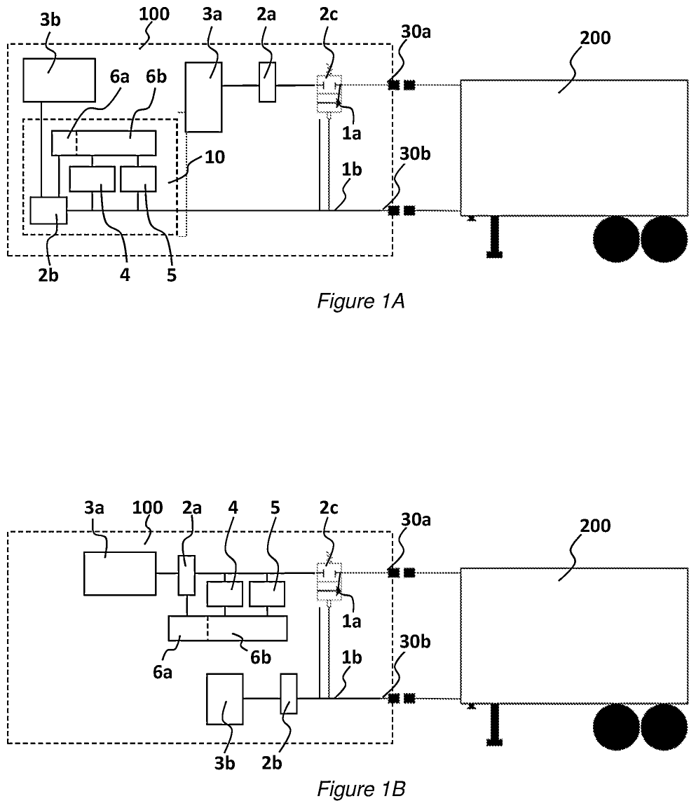

FIG. 1A shows a simplified schematic of a preferred embodiment of the system according to the invention;

FIG. 1B shows a simplified schematic of a further preferred embodiment of the system according to the invention;

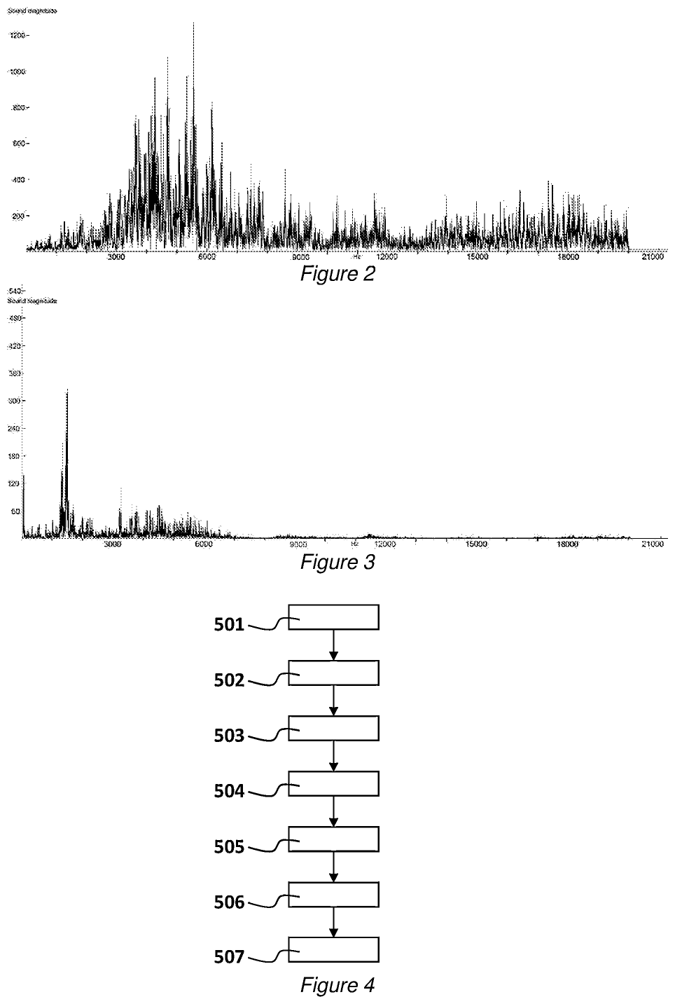

FIG. 2 shows a Fourier-transform of the sound recorded by the acoustic sensor during controlled release of air with no trailer attached;

FIG. 3 shows a Fourier-transform of the sound recorded by the acoustic sensor during controlled release of air with trailer attached; and

FIG. 4 shows a flow chart of the method according to the invention.

FIG. 1A shows a simplified schematic of a preferred embodiment of the system according to the invention. A vehicle combination comprises a tractor 100 and a trailer 200. The trailer 200 is mechanically connected to the tractor 100 so that the tractor 100 can tow the trailer 200. In the case of semi-trailers, the mechanical connection is usually provided by a so-called fifth wheel on the tractor 100 and a kingpin on the trailer 200. The tractor 100 and the trailer 200 are also connected electrically for controlling lights on the trailer 200, and they are also connected pneumatically for controlling brakes on the trailer 200. Usually, both the tractor 100 and trailer 200 pneumatic systems have two separate sets of pneumatic lines: supply lines for supplying every component with compressed air and for controlling the operation of the parking brakes (aka. emergency brakes), and control lines for controlling the operation of the service brakes via appropriate relay valves. The terms ‘control lines’ and ‘supply lines’ are used according to ISO standards, while the corresponding terms ‘service lines’ and ‘emergency lines’ are used in the U.S. based SAE standards. These terms are respectively synonymous and may be used interchangeably.

The tractor 100 comprises a pneumatic control line 1a for controlling the service brakes of the trailer 200 and pneumatic supply line 1b for supplying compressed air to the brakes of the trailer 200 and for controlling parking brakes of the trailer 200. The control line 1a and the supply line 1b are connected to corresponding connectors of the trailer 200 via a control line coupling head 30a and a supply line coupling head 30b respectively. Without a connected trailer 200, the coupling heads 30a, 30b are open to the environment according to SAE standards, i.e., on a vehicles based on FMVSS, while they are closed according to ISO standards, i.e., on a vehicles based on ECE13 (‘Regulation No 13 of the Economic Commission for Europe of the United Nations (UN/ECE)—Uniform provisions concerning the approval of vehicles of categories M, N and O with regard to braking’).

When the trailer 200 is mechanically connected to the tractor 100, but any of the control line 1a and the supply line 1b is not connected or the connection is faulty, the operation of the vehicle in not safe and thus such a situation should be detected as soon as possible, and further operation should be avoided.

The invention is based on the recognition, that controlled release of compressed air can be used to differentiate between a connected or disconnected status of a pneumatic line, as well as to detect an air leak, possibly indicative of an imperfect connection of the pneumatic head corresponding to the pneumatic line, if an acoustic sensor 4 is arranged at a corresponding pneumatic line and the sound produced by the controlled release is analyzed by a computer. Neither human hearing, nor an acoustic sensor arranged remotely from the pneumatic lines is reliable enough to perform this task. The term ‘controlled release’ means, that at least one of the parameters of the release is controlled, particularly its duration and/or the amount of released air.

The control line 1a and the supply line 1b are connected respectively to a service brake pneumatic system 3a of the tractor 100 and a parking brake pneumatic system 3b of the tractor 100 via a service brake valve 2a and a parking brake valve 2b respectively. The service brake valve (2a) and the parking brake valve (2b) may be (and usually are) pneumatically controlled relay valves, but alternatively they may be mechanically or electrically controlled valves. The control line 1a and the supply line 1b are usually connected to a tractor protection valve 2c. The function of the tractor protection valve 2c is to prevent loss of service brake control on the tractor 100 when a trailer 200 breaks away, which would open both the control line 1a and the supply line 1b to the environment, making both dysfunctional. Upon trailer breakaway, the pressure loss in the trailer supply line 1b causes the tractor protection valve 2c to close the control line 1a thus preventing loss of pressure in the control line 1a that would prevent controlling the brakes of the tractor 100. The pneumatic systems of the tractor 100 comprise numerous further components known to a person skilled in the art but are omitted in the Figure for the sake of simplicity and because the specifics of these further components are not particularly significant in relation to the present invention.

One acoustic sensor 4 may be arranged at the pneumatic control line 1a between the service brake valve 2a and the control line coupling head 30a for determining a control line connection status and/or one acoustic sensor 4 may be arranged at the pneumatic supply line 1b between the parking brake valve 2b and the supply line coupling head 30b for determining a supply line connection status. Arrangement ‘at’ a pneumatic line may mean arrangement within said pneumatic line, arrangement on the outside wall of a pneumatic line, in contact with said wall, or at a short distance therefrom, especially in the vicinity of a corresponding coupling head. The appropriate arrangement shall be selected according to the type of acoustic sensor 4 used. For example, a contact microphone shall be arranged in contact with the wall of the pneumatic line either inside or outside the pneumatic line, while a moving-coil microphone or a capacitor microphone may be arranged within the pneumatic line if that specific microphone is capable of withstanding pneumatic pressures occurring in that specific pneumatic line, while less durable and cheaper microphones may be used outside the pneumatic line, in close proximity thereof, e.g., within 30 centimeters from the corresponding coupling head.

Said acoustic sensor 4 may be arranged in the control line 1a either upstream or downstream of the tractor protection valve 2c. Said acoustic sensor 4 may be arranged in the supply line 1b either upstream or downstream of connection point of the supply line 1b to the tractor protection valve 2c. Safe operation of the vehicle combination requires the connection of both the control line 1a and the supply line 1b, and thus preferably two acoustic sensors 4 are used: one in each of the control line 1a and the supply line 1b.

The acoustic sensor 4 is in data communication with a processing unit 6b. The data communication may be analogue or digital and may be provided via a wire or wirelessly. The processing unit 6b is preferably in data communication to an electric control unit 6a of the tractor and even more preferably, the processing unit 6b and the control unit 6a are the same integrated unit. One or both of the processing unit 6b and the control unit 6a may be formed by an on-board control computer of the tractor 200 for complete autonomy. Alternatively, especially in the case of remote-controlled vehicles, the processing unit 6b may be a remote computer, e.g., a server, while the control unit 6a may be a simple microprocessor or integrated control unit. The processing unit 6b is configured for processing data received from the acoustic sensor 4 and optionally from one or more further sensors. The acoustic sensor 4 is preferably capable of recording sounds in the frequency range audible to humans, i.e., between about 20 Hz and 20 kHz. A huge variety of such acoustic sensors 4 are readily available on the market. For the purposes of the present invention, preferably such a model is selected, that is significantly smaller than the diameter of the pneumatic supply line 1b or control line 1a, and preferably it is also durable, i.e., not damaged easily by vibrations inherently present in the tractor 100.

In the embodiment shown in FIG. 1A, only a single acoustic sensor 4 is arranged between the supply line coupling head 30b and the parking brake valve 2b, thus the embodiment shown in FIG. 1A is only suitable for determining the status of the supply line coupling head 30b. When only a single acoustic sensor is used, this is a preferred arrangement due to the differing acoustic properties of the supply system and the control system on the trailer, which will be discussed later in the present description. It is hereby noted that arrangement of only a single acoustic sensor 4 between the tractor protection valve 2a and the control line coupling head 30a is also possible.

Optionally, a pressure sensor 5 may also be arranged in one or both of the control line 1a and the supply line 1b, wherein said pressure sensor 5 is in wired or wireless data communication with the processing unit 6b. The pressure sensor 5 may be used for additional diagnostic purposes, e.g., to determine whether an acoustically detected leak is dangerous to the operation or not, specifically for determining the rate of air loss from a pressurized line. The pressure sensor 5 may also facilitate the determination of the connection status when the acoustic measurement and analysis is inconsequential for some reason. The pressure sensor 5 is preferably arranged in the same one or both of the control line 1a and the supply line 1b as the acoustic sensor 4, but alternatively it is also possible to arrange only the pressure sensor 5 in one of the pneumatic lines, especially in the control line 1a, because of the smaller volume of this line, that causes a significant pressure increase even when only a short air burst is introduced. Thus, for example it is possible to use an acoustic sensor 4 for the monitoring of the supply line 1b and a pressure sensor for monitoring the control line 1a. Furthermore, the pressure sensor 5 may be integrated into the acoustic sensor 4. Particularly, the actual design and/or arrangement of the acoustic sensor 4 may allow the acoustic sensor itself to be used for measuring pressure.

Optionally a further sensor is arranged on the tractor 100 for detecting mechanical connection of a trailer, e.g., a load sensor at the rear axles or at the fifth wheel to detect the load presented by a semi-trailer, or any other type of when a mechanical connection between the tractor 100 and the trailer 200 is engaged. Said further sensor may also be a proximity sensor or a mechanically operated electrical switch that produces an electrical signal. Such a further sensor is particularly preferable for implementation of further automated operations on the basis of the signal of the acoustic sensor 4. For example, an alert may be provided to the driver and/or the take-off of the vehicle may be prevented if a pneumatic line is not connected and a mechanical connection is detected.

In the preferred embodiment shown in FIG. 1, every component of the system is arranged on the tractor 100. This arrangement is preferable, because allows the upgraded tractors 100 to be used with any unmodified trailers without any compatibility issues, or—if viewed on a larger scale—upgrading a fleet of vehicles with the system according to the invention requires only the upgrading of the tractors of the fleet, while the trailers may stay unchanged.

According to the exemplary embodiment shown in FIG. 1A, both an acoustic sensor 4 and a pressure sensor 5 is present and arranged within the supply line 1b and are integrated into—together with the control 6a and processing 6b units and the parking brake valve 2b—an electronic parking brake system 10. This embodiment is particularly preferable for retrofitting the manually controlled pneumatic system of an older vehicle by an electronic parking brake system 10, because a new electronic control unit 6a is needed anyway and there is no pre-existing electronic system that would need replacement, rewiring or reprogramming.

FIG. 1B shows a simplified schematic of a further preferred embodiment of the system according to the invention, wherein the same components are denoted with the same reference numbers as in FIG. 1A, and their operation is practically the same and thus for the sake of conciseness, not repeated herein. FIG. 1B shows an embodiment, where the acoustic sensor 4 and the pressure sensor 5 are arranged in the control line 1a, upstream of the tractor protection valve 2c. Alternatively, the acoustic sensor 4 and the pressure sensor 5 could be arranged downstream of the tractor protection valve 2c. Both configurations are suitable for use in the system according to the invention, however, detectable physical phenomena caused by releasing compressed air is different under some connection statuses of the pneumatic lines for a sensor position upstream of the tractor protection valve 2c and for a sensor position downstream of the tractor protection valve 2c. This shall be taken into account when evaluating measurement results and determining pneumatic connection status.

For example, when the supply line 1b is disconnected and compressed air is sent through the service brake valve 2a, the tractor protection valve 2c remains closed, and thus sensors upstream of the tractor protection valve 2c could detect a pressure increase and acoustic phenomena characteristic of a small-volume closed system (i.e., the tractor 200 service brake system operates normally, but without operating the trailer 100 service brake system), while sensors downstream of the tractor protection valve 2c could detect no pressure change, and at most a faint acoustic signal as the operated pneumatic line is not in fluid communication with the acoustic sensor 4. Thus, arranging the sensors in the control line 1a has the drawback, that they cannot determine the connection status of the control line 1a if the supply line 1b is disconnected, but this has the advantage, that sensors in the control line 1a may be used for determining if the supply line 1b is disconnected.

On the other hand, when the supply line 1b is connected and is pressurized to its nominal pressure, the tractor protection valve 2c is open, and thus when compressed air is sent through the service brake valve 2a, sensors in the control line 1a may detect pressure change and acoustic phenomena according to the connection status of the control line 1a. When the control line 1a is connected, a pressure increase and acoustic phenomena characteristic of a relatively small-volume closed system is detectable. When the control line 1a is disconnected, a short pressure increase and return to atmospheric pressure may detected, along with the hissing noise of compressed air release to the environment.

FIGS. 2 and 3 show Fourier-transforms of the sound recorded by the acoustic sensor during controlled release of air without and with a trailer attached respectively. In this example, controlled release is performed by completely opening the parking brake valve 2b and completely closing it 500 ms later, i.e., a half-second long air burst had been used. Frequency is shown on the horizontal axis in units of Hertz and sound magnitude is shown on the vertical axis in arbitrary units. The sounds have been recorded by an acoustic sensor 4 arranged in the supply line 1b of a tractor 100, between the tractor protection valve 2a and the control line coupling head 30a as shown in FIG. 1A.

It is visible in FIGS. 2 and 3 that the spectral composition of the sound is significantly different in the two cases. In FIG. 2, i.e., when exhausting air to the environment, the total sound power is greater, the amplitude of the highest amplitude spectral component is higher, the frequency of the highest amplitude spectral component is larger, and the amplitude and power of noise in the high frequency ranges are also larger than in FIG. 3, i.e., when a trailer is attached. Any one or more of these differences may be used for determining whether the trailer is pneumatically connected to the tractor or not.

In FIG. 3, a very significant portion of the sound power—the area under the curve—is concentrated in the relatively narrow 1200-1700 Hz frequency range. This is the result of the short air burst introduced into the air supply system of the trailer, because said supply system comprises several meters long pneumatic lines and a relatively large metallic supply tank having a volume of several liters. With other words, a short exciting pulse in a resonant system causes vibrations corresponding to the characteristic frequencies of the resonant system—which in turn may be easily identified automatically. This is of course complemented to some extent by a noisy hissing sound generated by the gas flowing through a relatively small opening. However, the hissing sound is a lot louder when the air escapes into the environment. Thus, the ratios of the amplitudes, frequencies and/or powers of the resonant sound resulting from air released into a closed system and of the hissing sound generated by the air flow provide an opportunity for automatic differentiation between a connected, absent, or leaky pneumatic system of the trailer. In the example above, a trailer supply system has been used, but the same general considerations are true for the pneumatic service brake control system of the trailer. There is no tank in the control system and thus it presents a smaller closed volume, which results in different characteristic frequencies and a quicker raise in the pressure, which could also be visible in the Fourier transform as a higher amplitude spike in the very low frequencies of about 0-100 Hz (a so-called DC component in the Fourier transform, whose apparent frequency often corresponds to the reciprocal value of the temporal length of the measurement instead of an actual frequency of a one-time event).

FIG. 4 shows a flowchart of the method according to the invention. The method according to the invention is started upon receiving a trigger signal 501. The trigger signal may be produced manually, i.e., a driver may decide when to initiate method. The trigger signal is preferably automatically generated when the driver would start a take-off maneuver, e.g., when release of the parking brakes of the tractor is detected. The trigger signal may be any of a mechanical, pneumatic, or electric signal that is detectable by a control unit. After receiving the trigger signal 501, compressed air is released 502 via a pneumatic line, e.g., via the supply line 1b in the embodiment shown in FIG. 1A or via the control line 1a as shown in FIG. 1B or both. Releasing 502 compressed air produces a sound that is detected 503 by an acoustic sensor 4 that is arranged at said pneumatic line and the sound is converted to data signals. For example, the acoustic sensor may be a microphone, that converts the sound to electrical signals. These electrical signals may be transmitted 504 as analogous data signals through electrical wires to a processing unit 6b without any further amplification, filtering, or conversion. Alternatively, in order to increase the reliability of data transmission, said electrical signals may be amplified, digitized and/or converted to other types of signals before transmitting, e.g., to optical signals for transmission through optical fibers or to microwave or radio signals for wireless transmission.

The transmitted data signal is processed 505 in a processing unit 6b preferably by spectral analysis. More specifically, preferably the time-domain data signal is transformed into frequency-domain by the use of e.g., Fourier transform, Gabor transform, or wavelet transform, and then the frequency spectrum is analyzed further. Analysis of the frequency spectrum preferably comprises identifying at least one characteristic feature that corresponds to a pneumatic connection status of the trailer. Such a characteristic feature may be related to the amplitude and frequency of specially selected spectral components or to the sound power in specific frequency ranges. One or more of these characteristic features may be used in comparison with predetermined thresholds for determining 506 the pneumatic connection status. The following examples serve as illustrations and are based on the exemplary measurements shown in FIG. 2 and FIG. 3.

The characteristic feature may be the total sound power detected within a predetermined frequency range. Said predetermined range may be the whole audible range, i.e., from 20-20000 Hz or preferably a subrange thereof, e.g., 1000-2000 Hz and/or 4000-5000 Hz. More specifically, if the sound power in the 1000-2000 Hz range is larger than a threshold, the pneumatic line may be considered connected. Alternatively, if the sound power in the 4000-5000 Hz range is larger than a threshold, the pneumatic line may be considered disconnected. Furthermore, if both previous two statements seem to be true, the measurement may be deemed inconclusive, which is a possible result due to environmental noises, and may be repeated. Yet further, if the sound power is greater than its corresponding threshold in both frequency ranges, i.e., both the sounds that are characteristic to the closed pneumatic system and sounds characteristic to the release of air to ambient pressure are audible, that may indicate a leak, that may be caused an incorrect connection or a tightness fault in a correctly connected system. The specific frequency range, for which the sound power is calculated, may be tied to a highest amplitude spectral component, for example, the power may be calculated in a range of ±200 Hz around the frequency of the highest amplitude spectral component identified in that measurement.

Similarly to the previous example, the characteristic feature may be the amplitude of a highest amplitude spectral component, for example if the highest amplitude component has an amplitude above 800 units, the pneumatic connection status may be considered to be disconnected, while below 800 units, it is considered to be connected. Of course, these thresholds shall be determined for the actual system, here they only serve illustrative purposes.

Frequency of the highest amplitude spectral component may also serve as the characteristic feature. For example, when the frequency of the highest amplitude spectral component is under 3000 Hz, as visible on FIG. 3, the pneumatic connection status may be considered to be connected, and when the frequency of the highest amplitude spectral component is above 3000 Hz, as visible on FIG. 2, the pneumatic connection status may be considered to be disconnected.

Said characteristic feature may be the amplitude or frequency of the highest amplitude spectral component of a restricted frequency range. The purpose of this restriction is to avoid artifacts or external noises. For example, the highest amplitude spectral component may be sought in the frequency range of 1000-6000 Hz and amplitude or frequency thereof is then compared with a corresponding threshold.

Preferably not only a single parameter is tested against a threshold, but relations (e.g., ratios or differences) of the aforementioned parameters are examined. This is advantageous, because reduces the effect of external noises and effect of variations in the parameters of different pneumatic systems of different trailers and thus increases the reliability of the status determination.

Accordingly, said characteristic feature is preferably a ratio of sound power within a predetermined frequency range around the frequency of the highest amplitude spectral component and sound power within a predetermined frequency range, e.g., the whole range. If this ratio is higher than a threshold, that means that a characteristic sound in a relatively narrow wavelength range is relatively loud compared to the more random noise of the escaping compressed air, and thus is indicative of a connected pneumatic system.

According to a further preferred example, said characteristic feature is a ratio between the amplitude or the frequency of a highest amplitude spectral component of a first frequency range and the amplitude or frequency of a highest amplitude spectral component within a second frequency range. The first and second frequency ranges may be 1000-2000 Hz and 3000-7000 Hz respectively. This way said amplitude ratio would be about 0,14 in the analysis corresponding to FIG. 2 and about 4,5 in the analysis corresponding to FIG. 3, showing a great difference between connected and disconnected pneumatic systems.

Furthermore, said selected amplitude or power values may also be compared to noise levels or average levels of their corresponding values.

Sound magnitude may be defined by e.g., the amplitude, intensity, amplitude squared, power per unit frequency, or sound pressure on a logarithmic decibel scale etc.

Accordingly, the aforementioned relations shall be changed accordingly, for example ratio of amplitudes transform into differences of sound pressure, due to the latter being the logarithmic function of the former. Such mathematical transformations are trivial to a person skilled in the art and thus not detailed further but shall always be taken into account in relation to the present invention.

The time period for the detection 503 of the sound or the time period for which the data signals are processed 505 may be the same as the time period of the release 502 of the compressed air. Alternatively, the detection 503 or the data processing 505 may be started a short, e.g., 50 ms, delay after the start of the air release 502 in order to avoid or at least reduce artifacts generated by transient phenomena at the start of the air release. Furthermore, the detection 503 or the data processing 505 may last longer, e.g., by 500 ms, than the air release 502 in order to more reliably detect leaks or incorrect pneumatic connection by detecting a softer hissing sound possibly present due to the air leaking out of the now pressurized system.

The method according to the invention preferably further comprises taking 507 a further action on the basis of the determined pneumatic connection status. Said further action may be providing an audible or visual alert to the driver or to a remote location, wherein said alert corresponds to the pneumatic connection status.

According to a further preferred variant of the method according to the invention, at least one further measurement is made beyond the acoustic measurement. Said further measurement may be any one or more of a pressure measurement, detection of a mechanical connection, and/or detection of proximity.

A pressure measurement may be used for aiding in the determination of the pneumatic connection status, e.g., when the measured pressure is higher than a threshold at least for a specific time interval during the air release, the pneumatic line is probably connected. Additionally, or alternatively, in the case of the supply line, the measurement of the pressure may last significantly longer than the air release and the airtightness of the trailer supply system may be tested thereby: if the pressure drops by an amount that is larger than the threshold during a predetermined time period, the pneumatic system may be leaking, possibly via an incorrect connection.

When said further measurement is the detection of proximity or mechanical connection of a trailer, then the result of this information may be used for both improving driver comfort and improving operation safety by not producing unnecessary alerts to the driver and by avoiding further dangerous situations. More specifically, when the pneumatic connection status determined 506 on the basis of the acoustic detection 503 is ‘disconnected’ taking 507 a further action may be unnecessary if the mechanical connection is also disconnected or there is no trailer in proximity, i.e., it is safe to take-off with unconnected pneumatic lines if there is no trailer connected. On the other hand, it is unsafe to take-off with connected pneumatic lines if the trailer is not connected mechanically, because this leaves the trailer behind resulting in the connected pneumatic components to be violently torn off, usually resulting their damage and/or complete loss if the situation is not detected promptly. Accordingly, the further action should be taken 507 if the status of the mechanical connection or proximity contradicts the pneumatic connection status in any way. Preferably, said further action comprises an alert corresponding to not only the pneumatic connection status, but also to mechanical connection and/or proximity status.

The method and the system according to the invention provide a simple and robust solution for detecting whether a trailer is pneumatically connected and for detection of a possible fault in the connection. The design of the system makes it relatively cheap and allows its installation on pre-existing tractors, while its reliability surpasses that of the prior art solutions.

1. A system for determining a pneumatic connection status of a trailer (200) relative to a tractor (100), wherein said system comprises:
a control unit (6a) for controlling the operation of a service brake valve (2a) and/or a parking brake valve (2b);
at least one acoustic sensor (4) for detecting sounds and transmitting corresponding acoustic data;
a processing unit (6b) that is in data communication with the acoustic sensor (4) for receiving said acoustic data, wherein said processing unit (6b) is configured for processing said acoustic data and for determining a pneumatic connection status of the trailer (200) at least on the basis of said acoustic data,
characterized in that
said at least one acoustic sensor (4) is arranged:
at a trailer service brake control line (la) of the tractor (100), between the service brake valve (2a) and a control line coupling head (30a); and/or
at a trailer supply line (1b) of the tractor (100), between the parking brake valve (2b) and a supply line coupling head (30b).

2. The system according to claim 1, wherein the acoustic sensor (4) is arranged within a trailer supply line (1b) of the tractor (100), between a parking brake valve (2b) and a supply line coupling head (30b).

3. The system according to claim 1, wherein the processing unit (6b) is integrated with the control unit (6a).

4. The system according to claim 1, further comprising a pressure sensor (5) that is connected to
the trailer service brake control line (la) of the tractor (100), between the service brake valve (2a) and the control line coupling head (30a); and/or
the trailer supply line (1b) of the tractor (100), between the parking brake valve (2b) and the supply line coupling head (30b).

5. The system according to claim 1, wherein the processing unit (6b) is configured to provide an alert and/or to prevent take-off, when the determined pneumatic connection status is disconnected or leaking.

6. The system according to claim 1, further comprising a further sensor for determining a mechanical connection status of the trailer (200), wherein the mechanical connection status is either connected or disconnected, and wherein said further sensor is selected from a group comprising: a load sensor, an electro-mechanical switch and a proximity sensor.

7. The system according to claim 6, wherein the processing unit (6b) is configured to provide an alert and/or to prevent take-off, when the determined pneumatic connection status is not the same as the mechanical connection status.

8. The system according to claim 1, wherein every component of the system is arranged on the tractor (100).

9. A method for determining a pneumatic connection status of a trailer (200) relative to a tractor (100), wherein said method comprises:
receiving (501) a trigger signal;
releasing (502) compressed air via a pneumatic line so as to produce a sound;
detecting (503) the sound produced by the release (502) of compressed air and converting the sound to data signals;
transmitting (504) the data signals to a processing unit (6b);
processing (505) the data signals so as to produce derived data;
determining (506) the pneumatic connection status of the trailer at least on the basis of the derived data.

10. The method according to claim 9, further comprising detecting pressure in the pneumatic line and wherein determining (506) the pneumatic connection status is also based on the determined pressure.

11. The method according to claim 9, further comprising detecting a mechanical connection and/or detecting proximity of the trailer (200) to the tractor (100), wherein it is further determined, whether the determined pneumatic connection status corresponds to the detection of the mechanical connection and/or to the detected proximity or not.

12. The method according to claim 9, wherein processing (505) of the data signal includes spectral analysis, comprising the identification of at least one characteristic feature from the group comprising:
total sound power within a predetermined frequency range;
amplitude of a highest amplitude spectral component;
frequency of the highest amplitude spectral component;
amplitude of a highest amplitude spectral component within a predetermined frequency range;
sound power within a predetermined frequency range around the frequency of a highest amplitude spectral component;
relation of sound power within a predetermined frequency range around the frequency of a highest amplitude spectral component and sound power within a predetermined frequency range;
relation of amplitude of a highest amplitude spectral component in a first frequency range and amplitude of a highest amplitude spectral component in a second frequency range;
relation of frequency of a highest amplitude spectral component in a first frequency range and frequency of a highest amplitude spectral component in a second frequency range;
relation of amplitude of the highest amplitude spectral component and the average amplitude of the noise;
relation of sound power within a predetermined frequency range around the frequency of a highest amplitude spectral component and noise power.

13. The method according to claim 9, wherein the determination (506) of the pneumatic connection status comprises determining whether a pneumatic line of the trailer (200) is connected to a corresponding pneumatic line of the tractor (100) or not.

14. The method according to claim 9, wherein the determination (506) of the pneumatic connection status further comprises determining if there is a leak in the pneumatic line.

15. The method according to claim 9, wherein the trigger signal is automatically generated when initiation of a take-off maneuver by a driver is detected.

16. The method according to claim 9, wherein the trigger signal is manually generated by a driver.

17. The method according to claim 9, wherein a further action (507) is taken on the basis of the determined pneumatic connection status, wherein said further action is provision of an audible or visual alert to the driver or to a remote location, wherein said alert corresponds to the pneumatic connection status.
